(19) United States
(12) Patent Application Publication
(10) Pub. No.: US 2017/0292690 A1
(43) Pub. Date: Oct. 12, 2017

(54) HEAT DISSIPATING REFLECTORS FOR LED LUMINAIRES

(71) Applicant: General Electric Company, Schenectady, NY (US)

(72) Inventors: Attila Rakos, Budapest (HU); Zoltan Hercz, Budapest (HU); Gabor Dull, Budapest (HU); Balazs Babanyecz, Budapest (HU)

(21) Appl. No.: 15/092,239

(22) Filed: Apr. 6, 2016

(51) Int. Cl. F21V 29/505; F21V 17/06; F21V 7/00

(52) U.S. Cl. CPC F21V 29/505; F21V 7/0066; F21V 17/06; F21Y 2115/10

(57) ABSTRACT

An outdoor lighting fixture, comprising:

a housing;

a light emitting diode (LED) board connected to the housing and comprising at least one LED light source; and
a thermally conductive reflector operably connected to a front side of the LED board and having an opening to allow light emitted from the at least one LED light source to pass through, wherein the sheet metal reflector comprises an inner reflective surface and an outer surface, and wherein the inner surface reflects light from the LED light source towards an illumination area and the outer surface radiates heat from the LED board into ambient air.

### FIELD OF THE INVENTION

The present disclosure generally relates to heat dissipating reflectors for luminaires. More particularly, the present subject matter relates to heat dissipating reflector designs for roadway light emitting diode (LED) luminaires.

BACKGROUND

Light fixtures for use outdoors typically include a light source, a reflector, shielding, and a lens. The light distribution pattern of light from the light source for such outdoor light fixtures is therefore defined by the reflector, lens, and any shielding.

Many highway and roadway lights historically used incandescent light sources, and more recently use high intensity discharge (HID) lamps that can provide adequate amounts of light. However, HID lighting has several drawbacks, including frequent lamp maintenance and/or poor color performance. In addition, many optical systems utilize badly designed light reflectors that result in poor control of the light emitted from the source. For example, streetlights are configured to provide reflective lighting primarily in three different zones along a roadway. A first zone may be referred to by those of skill in the art as Nadir, and the Nadir typically includes the area directly below the streetlight. For streetlights located adjacent a highway (having vehicles traveling along the roadway at night), a second zone includes an area in the direction of traveling vehicles (which area is thus ahead of the traveling vehicles and illuminated in a direction away from the eyes of a driver of a vehicle). A third zone includes light from the roadway light fixture that shines in a direction opposite to that of the traveling vehicle (and thus towards the driver), which can be a vitally important aspect. In particular, care must be taken to ensure that any light directed towards traveling vehicles (and thus into the eyes of the driver) is of sufficiently low illuminance so as not to cause undue glare so as to distract or “blind” drivers. These three zones or areas generally represent the three roadway reflective lighting zones.

Roadway light fixtures that are poorly designed can also waste light by illuminating areas around the roadway (and potentially, on sidewalks) that do not require light. Poorly controlled light from such roadway light fixtures may also contribute to trespass light and/or light pollution (for example, stray light impinging on windows of private residences), which can interfere with the preservation of the nighttime environment. In many cases, poorly controlled light relates to the optical system's reflector design.

Roadway light fixtures may include a single or multi-part reflector design. For example, a two-part design typically includes a left reflector and a right reflector, whereas a three-piece reflector design can include two side reflectors and a middle part. In addition, many reflectors are manufactured using reflective material coating processes which may include physical vapor deposition processes and/or chemical vapor deposition processes. During many of such coating processes, the reflector parts are spherically rotated during the coating process which can cause certain areas of the reflector to be “shaded” or blocked.

Many municipalities are currently installing LED street lights which utilize light emitting diodes (LEDs) as the light source. Such LED street lights have extremely long lives, are highly energy efficient, and do not contain toxic chemicals like mercury. Since they are long-lived, LED street lights have reduced maintenance costs. In some LED street light designs, an LED light cluster is sealed on a panel and then affixed to an LED panel with a heat sink to become an integrated lighting fixture, and different designs incorporate various types of LEDs. For example, high-power LEDs (HP-LEDs) or high-output LEDs (HO-LEDs) have been used, and such LED light sources may be driven at currents ranging from hundreds of milliamps (mA) to more than an ampere, compared with the tens of mA for other LED light sources. In fact, some HP-LEDs emit over a thousand lumens, and LED power densities up to 300 W/cm² have been achieved. When HP-LEDs (or HO-LEDs) are utilized, overheating is a concern, and thus the HP-LEDs are typically mounted onto a heat sink to allow for heat dissipation on a back side of the LED board. If the heat from a HP-LED is not removed, the device will fail in seconds.

Therefore, it would be advantageous to provide a low cost LED luminaire assembly that efficiently dissipates heat from an LED board to provide improved junction temperatures (cooler operating temperatures) and thus extend the useful life of the LED light sources.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments (not necessarily drawn to scale), wherein:

FIG. 1 is a cutaway side view of an outdoor lighting fixture in accordance with embodiments of the disclosure;

FIG. 2A is an exploded bottom perspective view of an outdoor LED lighting fixture in accordance with some embodiments of the disclosure;

FIG. 2B is an unexploded bottom perspective view of the LED lighting fixture of FIG. 2A; and

FIG. 3 is a perspective top view of a fully assembled LED lighting fixture in accordance with the LED lighting fixture shown in FIGS. 2A and 2B and according to embodiments of the disclosure.

### DETAILED DESCRIPTION

Reference now will be made in detail to illustrative embodiments, one or more examples of which are illustrated in the drawings. Each example is provided by way of explanation only and thus does not limit the invention. In fact, it will be apparent to those skilled in the art that various modifications and/or variations can be made without departing from the scope and/or spirit of the invention. For instance, in many cases features illustrated or described as part of one embodiment can be used with another embodiment to yield a further embodiment. Thus, it is intended that the present disclosure covers such modifications and variations as come within the scope of the appended claims and their equivalents.

Embodiments described herein relate to a light emitting diode (LED) light fixture or LED luminaire for illuminating an outside area and/or areas such as a roadway. More particularly, embodiments relate to an LED light fixture assembly that includes a sheet metal reflector that is configured and that functions to both reflect light from the LED light source towards an illumination area while at the same time dissipating heat from the LED light source. Disclosed embodiments therefore solve the technological problem of how to provide a low-cost and flexible light fixture reflector for an outdoor LED luminaire that improves the heat dissipation from the LED light sources while also increasing the lifetime and the efficacy of the product.

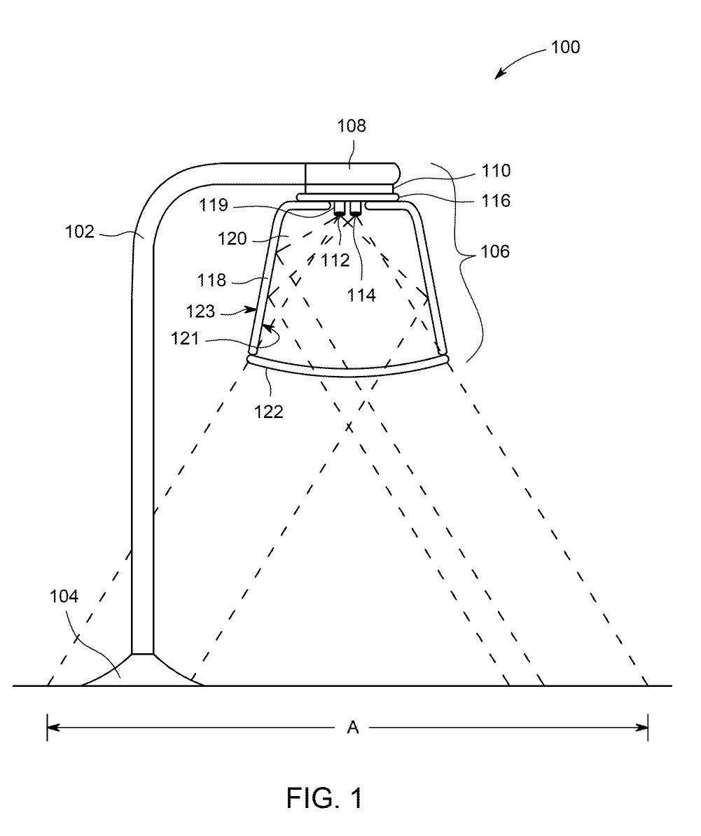

FIG. 1 is a cutaway side view of an outdoor LED lighting fixture 100 in accordance with some embodiments disclosed herein. The LED lighting fixture 100 includes a support pole 102, a base 104, and a LED light fixture assembly 106. In this case, the LED light fixture 100 is designed to provide light to an illumination area “A” on the ground below the light fixture assembly. The lighting fixture assembly 106 includes a housing 108 and a light emitting diode (LED) board 110 connected to and/or otherwise affixed to the housing 108 (i.e., housed within it).

In some embodiments, the LED board 110 includes a plurality of LED light sources, and two such LED light sources 112 and 114 are shown. It thus should be understood that more or less LED light sources may be utilized. Such LED light sources may be, for example, high-powered LEDs (HP-LEDs) or high-output LEDs (HO-LEDs), and in such cases a back side of the LED board 110 may also be affixed to a heat sink (not shown) for heat dissipation purposes. In some embodiments, the housing 108 can provide thermal dissipation functionality to the back side of the LED board 110. In some implementations, the lighting fixture assembly 106 also includes a thermal interface 116 that is operably connected to the front side of the LED board 110 (which includes the LED light sources 112 and 114). The thermal interface 116 has at least one opening (not shown) for accommodating the LED light sources 112 and 114 so that emitted light can pass through the thermal interface 116. In some embodiments, the LED light sources 112 and 114 are physically slotted through the at least one opening in the thermal interface.

The lighting fixture assembly 106 also includes a reflector 118 which is made of a thermally conducting metal material, which in some embodiment is aluminum. In some other implementations, the reflector 118 is made of a thermally conductive polymer material. The reflector 118 is operably connected to the thermal interface 116 and has interior reflective walls 121 for guiding light emitted from the LED light sources 112 and 114 towards the illumination area “A” below the LED lighting fixture 100, as shown. The sheet metal reflector 118 also includes an opening 119 that allows the light emitted from the LED light sources 112 and 114 to pass through. In some embodiments (as shown in FIG. 1), the LED light sources 112 and 114 are physically slotted through the opening 119 into a reflective chamber 120. In some embodiments, the reflective chamber 120 is defined by the reflective inner walls 121 of the sheet metal reflector 118 and a transparent cover 122, which may be placed over the distal end portion of the sheet metal reflector 118.

Referring again to FIG. 1, the thermal interface 116 may be made of a thermal rubber material, or a thermal glue, or a metal material capable of conduction heat, or a thermal composite material, or any other heat dissipating material. In addition, it should be understood that the outer surface 123 of the sheet metal reflector 118 operates to radiate heat away from the LED light sources 112 and 114 into the ambient air surrounding the LED lighting fixture 100. In some embodiments, the outer surface 123 is painted a dark color to increase thermal radiation. Thus, the outer surface 123 of the sheet metal reflector 118 may be painted, for example, a black color, a dark gray color or a dark blue color, so as to maximize its' heat dissipation characteristics.

In some embodiments, heat-conducting fasteners (not shown) may be used to connect the sheet metal reflector 118 to the thermal interface 116. In other embodiments, heat-conducting fasteners may be configured to connect the sheet metal reflector 118 to any or all of the thermal interface 116, the LED board 110, and/or to the housing 108. For example, screws composed of a heat-conduction metal or other thermal material may be utilized. In some other embodiments, the thermal interface 116 may be made of a thermal glue and operate to not only dissipate heat, but also to affix the reflector 118 to the LED board 110.

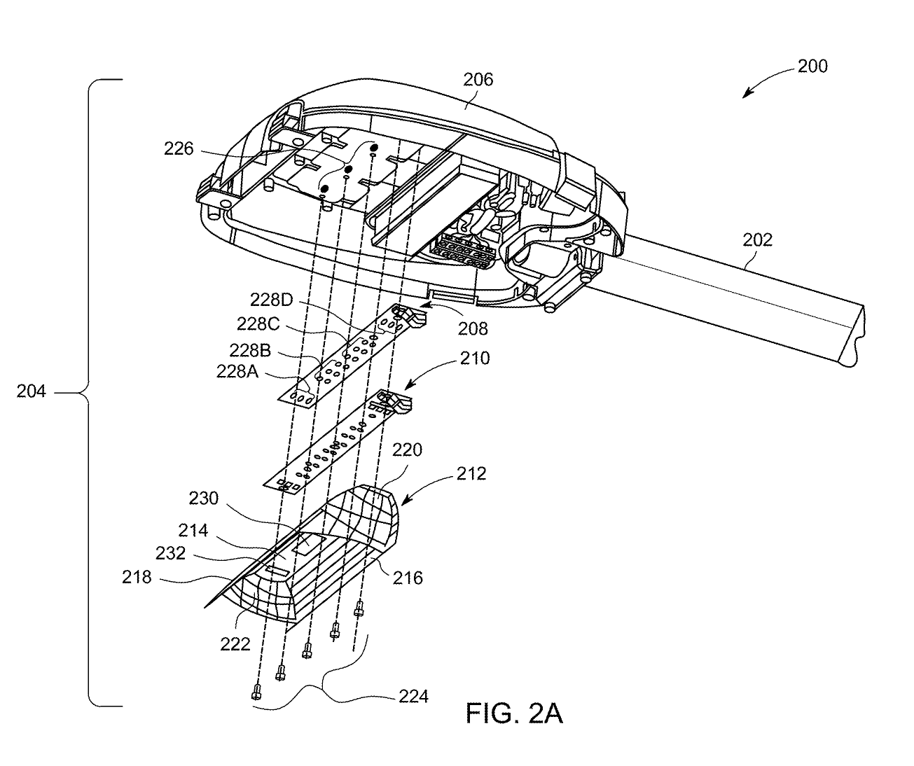

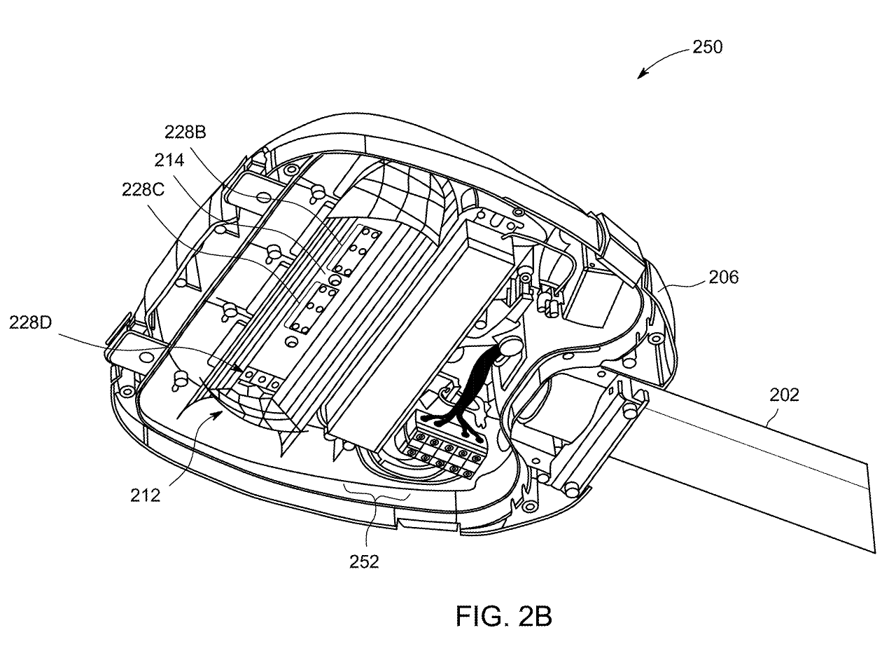

FIG. 2A is an exploded bottom perspective view of an outdoor LED lighting fixture 200 in accordance with some other embodiments. A portion of a support pole 202 is shown connected to an outdoor LED lighting fixture assembly 204. The LED light fixture assembly 204 includes a housing 206, a light emitting diode (LED) board 208 for connection to the housing 206, a thermal interface 210 for connection to the LED board 208, and a sheet metal reflector assembly 212 for connection to the thermal interface 210.

In some embodiments, the sheet metal reflector assembly 212 includes an elongated center piece 214, a first elongated side piece 216, a second elongated side piece 218, a first end piece 220 and a second end piece 222. The first elongated side piece 216 and the second elongated side piece 218 may be mirror images of each other, and the first end piece 220 and the second end piece 222 may also be mirror images of each other, but in some implementations this is not the case. In particular, the first and second elongated side pieces 216, 218 and the first and second end pieces 220, 222 may have different shapes depending on the light distribution required for a particular application (for example, roadway lighting) for the outdoor LED lighting fixture or LED luminaire 200. Each of the sheet metal reflector assembly pieces 214, 216, 218, 220 and 222 have reflective inner surfaces. In addition, the outer surfaces of the first and second elongated side pieces 216, 218 and the first and second end pieces 220, 222 radiate heat away from the LED board, wherein some of the thermal radiation is passed from the LED board 208 through the thermal interface 210 and to the sheet metal reflector assembly 212. In addition, in some implementations, the outer surfaces of the sheet metal reflector assembly pieces 216, 218, 220 and 222 are painted with a special thermal material to increase the heat dissipation or thermal radiation therefrom. For example, a dark color thermal paint may be applied to the outer surfaces of the sheet metal reflector assembly pieces 216, 218, 220 and 222, such as black, dark blue, dark gray and the like thermal paint material.

As shown in FIG. 2A, in some embodiments one or more fasteners 224 may be utilized to connect the reflector assembly 212, the thermal interface 210, and the LED board 208 to the housing 206. For example, the fasteners 224 may be fitted through slots or holes or apertures in each of the reflector assembly 212, the thermal interface 210, and the LED board 208 (as shown by the dotted lines in FIG. 2A) to mating receptacles 226 provided in the housing 206. In some implementations, the fasteners are made of thermally conducting material, such as metal screws. However, in other implementations other types of fasteners could be utilized. It should also be understood that, in some implementations the thermal interface 210 may include or be made of a thermal glue which affixes or cements the reflector assembly 212 to the LED board 208.

Referring again to FIG. 2A, in some implementations the LED board 208 includes a plurality of LED light sources 228A, 228B, 228C and 228D (wherein each such LED light source may include one or groups of LEDs), and in such cases the thermal interface 210 and the sheet metal reflector assembly 212 include openings and/or holes and/or apertures that line up with or match the positions of the LED light sources 228A, 228B, 228C and 228D so as to allow light emitted from them to shine through. In some embodiments, the holes and/or openings and/or apertures can be sized and positioned to allow the LED light sources 228A, 228B, 228C and 228D to physically fit through. For example, the elongated center piece 214 includes at least one central opening 230 and a side opening 232 for permitting light emitted from the LED light sources 228C and 228D, respectively, to shine through.

FIG. 2B is an unexploded bottom perspective view 250 of the LED lighting fixture of FIG. 2A in accordance with embodiments disclosed herein. The support pole 202 is connected to the outdoor LED lighting fixture assembly, which includes the light emitting diode (LED) board, thermal interface, and sheet metal reflector assembly 212 connected to the housing 206. In particular, the LED light sources 228B, 228C and 228D can be seen through the holes or apertures of the elongated central piece 214 of the sheet metal reflector assembly 212 and of the thermal interface (not shown in FIG. 2B, but shown as item 210 in FIG. 2A). FIG. 2B also shows the position of various LED lighting electronic components 252 (such as a ballast) for illuminating the LED light sources when electricity is provided.

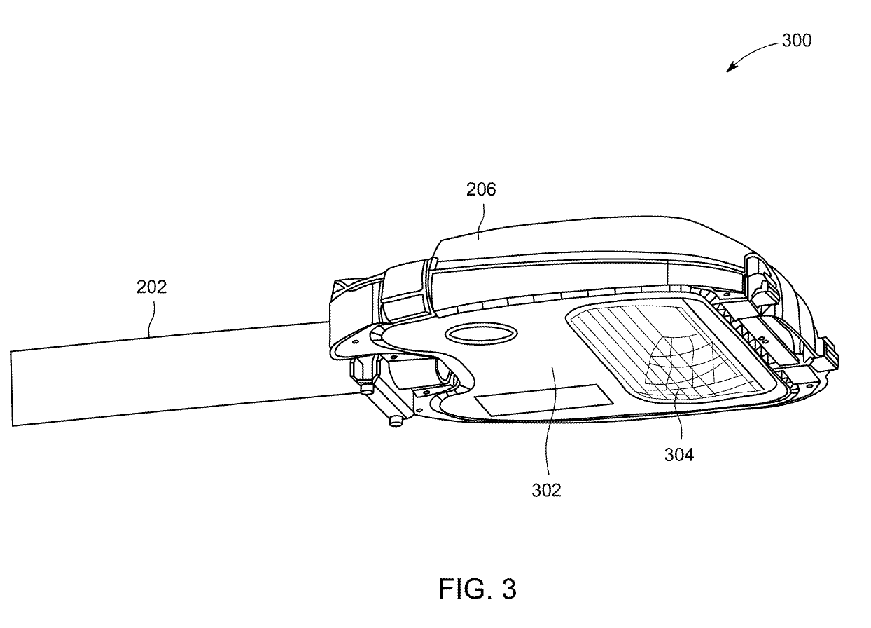

FIG. 3 is a perspective top view of a fully assembled LED lighting fixture 300 in accordance with the LED lighting fixture shown in FIGS. 2A and 2B and according to some embodiments. In particular, the pole or support station 202 is connected to the housing 206 of the LED lighting fixture assembly. The housing 206 also now includes a bottom cover plate 302 and a transparent cover 304. In some embodiments, the bottom cover plate 302 and transparent cover 304 are provided in order to protect the various electronic elements and/or components housed within the housing 206, such as the electronic power components and the light emitting diode (LED) board 208, the thermal interface 210, and the sheet metal reflector assembly 212.

The LED light fixture embodiments disclosed herein enhance heat dissipation of LED light sources by providing a thermally conductive reflector assembly (which may be made of, for example, sheet metal such as aluminum) on a front side (or LED source side) of the LED board. The thermally conductive reflector assembly thus increases the lifetime and the efficacy of the outdoor LED luminaire product. In addition, the non-reflective side (outer side) of the reflector pieces of the thermally conductive reflector assembly may be painted (using a special material such as dark thermal paint) to increase the thermal radiation effect. Yet further, in some embodiments a thermally conductive material is added between the thermally conductive reflector assembly and the front side of the LED board to further increase the cooling effect. Thermal cooling simulations have shown that LED luminaire embodiments that include the thermally conductive assembly configurations described herein can extend the useful lifetime of an LED luminaire by about five thousand hours. Thus, by using the disclosed technology, more efficient and longer lasting LED luminaires can be manufactured. In addition, smaller high-output (or high illumination) LED luminaires having similar performance which overcome thermal limitations associated with the design of reduced-size LED lighting fixtures can be manufactured. Further advantages include the possibility of providing lighter weight LED luminaries for many different outdoor use applications due to the fact that the design of a particular sheet metal reflector assembly is flexible and is lighter than comparable reflector assemblies in use today. For example, by using some embodiments of the sheet metal reflector assembly described herein, it is possible to reduce the weight of the LED luminaire reflector by between fifty and seventy percent (50%-70%) as compared to conventional reflectors. In addition, the tooling costs incurred for fabricating the sheet metal reflector assembly embodiments disclosed herein are lower than tooling costs for manufacturing conventional LED luminaire reflectors.

The disclosed embodiments solve the technological problem of how to provide a low-cost and flexible sheet metal reflector assembly for an outdoor LED luminaire that improves the heat dissipation from the LED board (having one or more LED light sources) which results in increased lifetime and improved efficacy of the product.

It should be understood that the above descriptions and/or the accompanying drawings are not meant to imply a fixed order or sequence of steps for any process or method of manufacture referred to herein. Thus, any disclosed process may be performed in any order that is practicable, including but not limited to simultaneous performance of one or more steps that are indicated as sequential.

Although the present invention has been described in connection with specific exemplary embodiments, it should be understood that various changes, substitutions, modifications and/or alterations apparent to those skilled in the art can be made to the disclosed LED luminaire embodiments without departing from the spirit and scope of the invention as set forth in the appended claims.

What is claimed is:

1. An outdoor lighting fixture, comprising:
a housing;
a light emitting diode (LED) board connected to the housing and comprising at least one LED light source; and
a thermally conductive reflector operably connected to a front side of the LED board and having an opening to allow light emitted from the at least one LED light source to pass through, wherein the sheet metal reflector comprises an inner reflective surface and an outer surface, and wherein the inner surface reflects light from the LED light source towards an illumination area and the outer surface radiates heat from the LED board into ambient air.

2. The outdoor light fixture of claim 1, further comprising a thermal interface operably connected to the front side of the LED board and to the thermally conductive reflector, wherein the thermal interface comprises an opening allowing light emitted from the at least one LED light source to pass through and operates to radiate heat away from the LED board.

3. The outdoor light fixture of claim 2, wherein the thermal interface comprises one of a thermal glue material, a rubber material, and a metal material capable of conducting heat, or a thermal composite material.

4. The outdoor light fixture of claim 1, wherein the outer surface of the thermally conductive reflector is painted a dark color to increase thermal radiation.

5. The outdoor light fixture of claim 1, further comprising at least one fastener connecting the thermally conductive reflector to the LED board.

6. The outdoor light fixture of claim 5, wherein the at least one fastener comprises at least one of a metal screw, a non-metal screw and a thermal glue.

7. The outdoor light fixture of claim 1, wherein the thermally conductive reflector comprises one of sheet metal or a thermally conductive polymer material.

8. A roadway luminaire, comprising:
a housing;
a light emitting diode (LED) board connected to the housing and comprising at least one LED light source; and
a thermally conductive reflector assembly operably connected to the LED board and comprising an elongated center piece, a first elongated side piece, a second elongated side piece, a first end piece and a second end piece;
wherein each of the thermally conductive reflector assembly pieces have reflective inner surfaces, the elongated center piece includes an opening to allow light emitted from the at least one LED light source to pass through, and wherein the thermally conductive reflector assembly pieces have outer surfaces that radiate heat away from the LED board to the housing and improve heat convection into a reflective chamber defined by the reflective inner surfaces thus increasing heat transfer from the LED board into ambient air.

9. The outdoor luminaire of claim 8, further comprising a thermal interface operably connected between the LED board and the thermally conductive reflector assembly and which radiates heat away from the LED board, wherein the thermal interface includes an opening that allows light emitted from the at least one LED light source to pass through.

10. The outdoor luminaire of claim 8, wherein the outer surfaces of the thermally conductive reflector assembly pieces further comprise a special thermal material that increases the heat dissipation from the LED board.

11. The outdoor luminaire of claim 10, wherein the special thermal material comprises a dark color thermal paint.

12. The outdoor light fixture of claim 8, wherein the thermally conductive reflector comprises one of sheet metal or a thermally conductive polymer material.
